(19) United States
(12) Patent Application Publication
(10) Pub. No.: US 2015/0350330 A1
(43) Pub. Date: Dec. 3, 2015

(54) COMMUNICATION PROTOCOL FOR TRANSPORT REFRIGERATION SYSTEM

(71) Applicant: THERMO KING CORPORATION, Minneapolis, MN (US)

(72) Inventor: Nathan Patrick LONGEN, Mahtomedi, MN (US)

(21) Appl. No.: 14/655,078

(22) PCT Filed: Dec. 31, 2013
(86) PCT No.: PCT/US13/78436

§ 371 Date: Jun. 24, 2015

Related U.S. Application Data
(60) Provisional application No. 61/747,439, filed on Dec. 31, 2012.

(51) Int. Cl. H04L 29/08

(52) U.S. Cl. CPC H04L 67/125; H04L 67/025; H04L 67/06

(57) ABSTRACT

A data communication protocol used to transfer data and/or files between various components in a TRS and/or used to transfer data and/or files between a TRU system and various consumer electronics employs a common communication protocol as a wrapper around various existing and future data transfer protocols. The transferred data and/or files are presented in an instruction set document format. The data communication protocol allows migration of current communication protocols and methods to modern, high speed communication buses and uses a defined generic data structure that accommodates a substantially non-exhaustive number of predetermined services that are supported by components associated with the TRS.

### FIELD

The embodiments disclosed herein relate generally a transport refrigeration system (TRS). More particularly, the embodiments relate to a system and method for transferring data and/or files between various components in a TRS or between a transport refrigeration unit (TRU) system and various consumer electronics such as personal computers (PCs, smart phones, tablet devices, and so forth).

### BACKGROUND

A transport refrigeration system (TRS) is generally used to control an environmental condition (e.g., temperature, humidity, air quality, and the like) within a refrigerated transport unit (e.g., a container on a flat car, an intermodal container, etc.), a truck, a box car, or other similar transport units (TUs). A TRS may include a transport refrigeration unit (TRU) that is attached to the TU and provides refrigeration within a cargo space of the TU. The TRU may include, without limitation, a compressor, a condenser, a thermo expansion valve, an evaporator and fans and/or blowers to facilitate heat exchange between the cargo space of the TU and the environment surrounding the TU.

In a cooling cycle, a refrigerant is compressed by the compressor and subsequently flows into the condenser. In the condenser, the compressed refrigerant can release heat to the environment. Then the refrigerant can pass through the thermo expansion valve where it can subsequently flow into the evaporator to absorb heat from air in a space desired to be cooled. A fan and/or blower can be used to facilitate heat exchange between the refrigerant and the environment when the refrigerant is in the condenser and the evaporator by creating air flow through the condenser and the evaporator.

Known TRS and TRU system communication protocols are commonly used to transfer data and/or files between various components in a TRS or between a transport refrigeration unit (TRU) system and various consumer electronics such as personal computers (PCs, smart phones, tablet devices, and so forth).

### SUMMARY

Embodiments described herein are directed to a data communication protocol used to transfer data and/or files between various components in a TRS and/or used to transfer data and/or files between a TRU system and various consumer electronics that may include without limitation, PCs, smart phones and tablet devices.

The embodiments described herein can transfer data and/or files between various components in a TRS and/or between a TRU system and various consumer electronics using modern, high speed communication buses. Also, the embodiments described herein can provide quicker software upgrade times, quicker data logger download times, quicker data send and retrieval times, quicker system data point refresh rates, and allow for migrating from USB to other hardware layers such as Wi-Fi, Bluetooth, and so on, and provide sharing of entire files between system components. That is, the embodiments described herein provide a TRS and/or TRU system communication protocol that can be easily applied using modern, high speed communication buses and that can be readily implemented on many hardware layers using standard communication drivers which are available “off the shelf” to achieve higher data communication rates to improve system performance.

An exemplary embodiment comprises a method of transferring data and/or files between various components in a transport refrigeration system (TRS) and/or transferring data and/or files between a transport refrigeration unit (TRU) system and various consumer electronics. The method may comprise wrapping predetermined existing and/or new data transfer protocols within a common communication protocol (an “off the shelf” communication protocol) formatted to perform predetermined operations. The method may further comprise invoking a predetermined operation by performing a GET or a POST command to one or more predetermined services that are supported by the TRS and/or TRU system components. The method my further comprise formatting predetermined service data into an instruction set document within the body of a common communication protocol message. The instruction set document can use any format language known by the various components in the TRS and the various consumer electronics. In some embodiments, the common communication protocol is hypertext transfer protocol (HTTP). In some embodiments, the format language is extensible markup language (XML) and the instruction set document can be an XML document.

According to another embodiment, a method of transferring transport refrigeration system (TRS) data associated with a TRS comprises defining a single data structure common to a substantially non-exhaustive number of predetermined services that are supported by components associated with the TRS; and programming at least one TRS controller associated with the TRS to transfer predetermined TRS service data contained within an instruction set document (e.g., an XML document) via a common communication protocol (e.g., hypertext transfer protocol (HTTP)), wherein the predetermined TRS service data conforms to the defined single data structure.

According to yet another embodiment, a transport refrigeration system (TRS) comprises a programmable integral controller that may comprise a single integrated control unit or that may comprise a distributed network of control elements. The TRS may further comprise a high speed data communication link that may be wired or wireless. The TRS may further comprise one or more external controllers in communication via the high speed data communication link with the integral controller using a common communication protocol (e.g., HTTP) encapsulating predetermined data, commands, and/or files. The predetermined data, commands, and/or files are further encapsulated within instruction set documents (e.g., XML documents).

### DRAWINGS

The foregoing and other features, aspects and advantages of the invention are apparent from the following detailed description taken in conjunction with the accompanying drawings in which like characters represent like parts throughout the drawings, wherein:

FIG. 1 illustrates one embodiment of a TRS comprising a TRU;

FIG. 2 is a schematic representation of a TRU illustrating data communications between various components associated with the TRU depicted in FIG. 1 and between various TRS components depicted in FIG. 1 and various consumer electronics devices according to one embodiment;

FIG. 3 is a block diagram illustrating TRS components typically associated with the type of refrigeration system which may be controlled according to the principles described herein;

FIG. 4 illustrates a common communication protocol as a wrapper around a predetermined data transfer protocol that is contained within the body of the common communication protocol message in an instruction set document according to one embodiment;

FIG. 5 illustrates a common communication protocol as a wrapper around a predetermined data transfer protocol that is contained within the body of the common communication protocol message in an instruction set document according to another embodiment;

FIG. 6 illustrates a common communication protocol as a wrapper around a predetermined data transfer protocol that is contained within the body of the common communication protocol message in an instruction set document according to yet another embodiment; and

FIG. 7 illustrates a common communication protocol as a wrapper around a predetermined data transfer protocol that is contained within the body of the common communication protocol message in an instruction set document according to still another embodiment.

While the above-identified drawing figures set forth alternative embodiments, other embodiments are also contemplated, as noted in the discussion. In all cases, this disclosure presents illustrated embodiments by way of representation and not limitation. Numerous other modifications and embodiments can be devised by those skilled in the art which fall within the scope and spirit of the principles of this disclosure.

### DETAILED DESCRIPTION

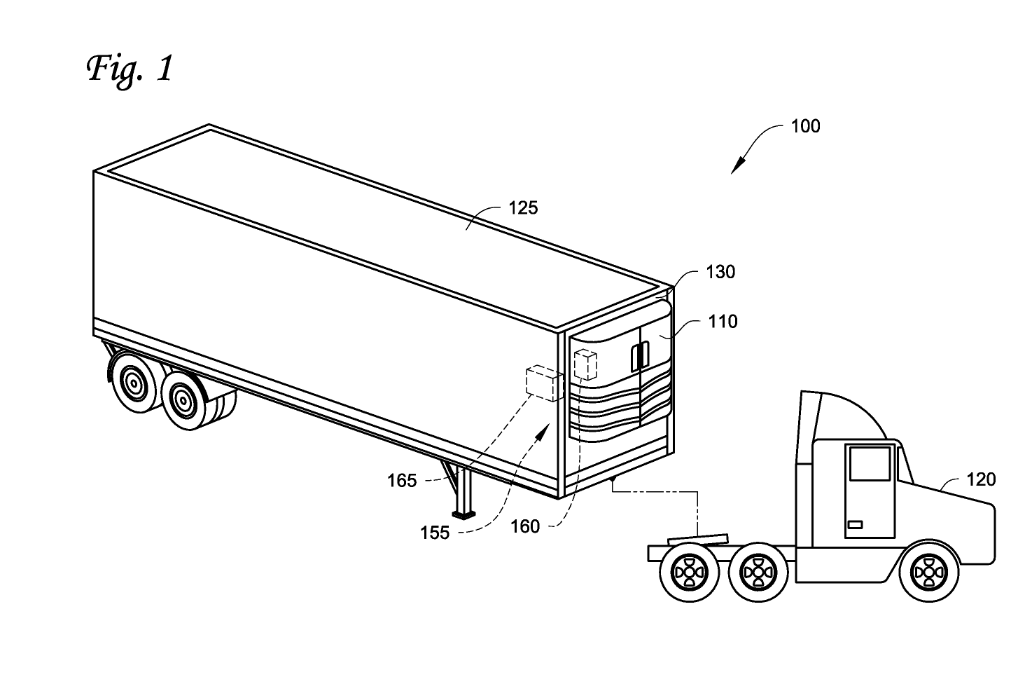

FIG. 1 illustrates one embodiment of a TRS 100 for a transport unit (TU) 125 that is attached to a tractor 120. The TRS 100 includes a TRU 110 that controls an environmental condition (e.g., temperature, humidity, air quality, and the like) within the TU 125. The TRU 110 is disposed on a front wall 130 of the TU 125. A tractor 120 is attached to and is configured to tow the transport unit 125. It will be appreciated that the embodiments described herein are not limited to trucks and trailer units, but can just as easily apply to any other suitable environmentally controlled apparatus including, for example, a container (e.g., a container on a flat car, an intermodal container, etc.), a truck, a box car, or other similar transport unit. The TRS 100 may further comprise a programmable controller 155 that may comprise a single integrated control unit 160 or that may comprise a distributed network of control elements 160, 165. The number of distributed control elements in a given network will depend upon the particular application of the principles described herein.

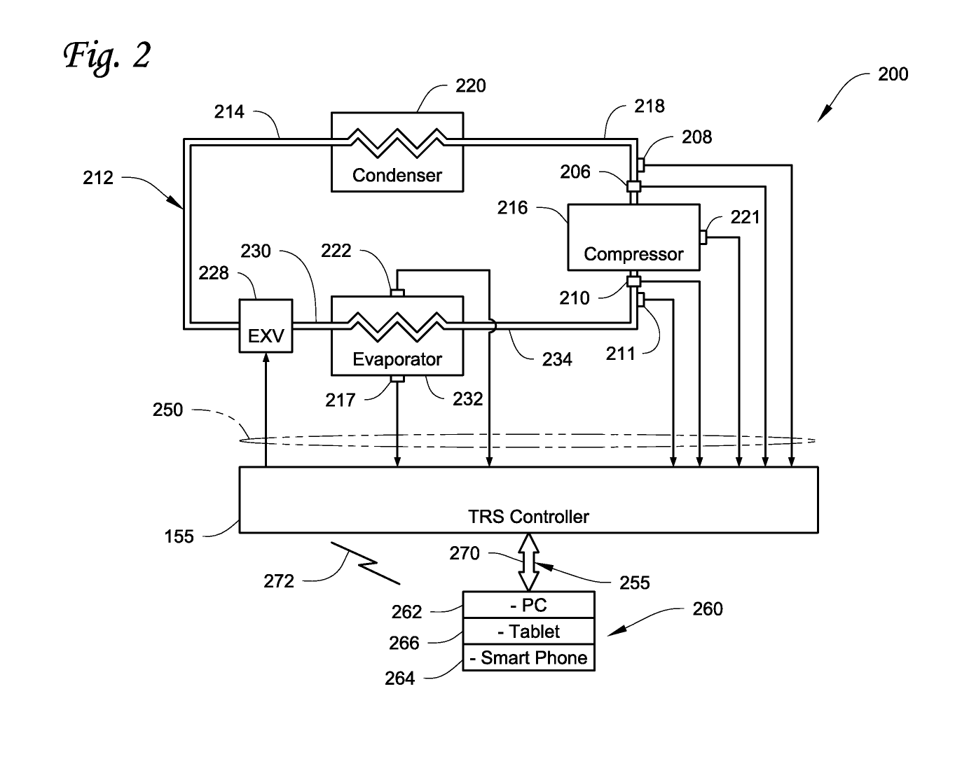

FIG. 2 is a schematic representation depicting one embodiment of a TRU 200 illustrating data communication links 250 between various components associated with the TRU 200 and a programmable TRS controller 155. The programmable TRS controller 155 may comprise a single independent control unit 160 or may optionally comprise one of a plurality of control elements 160, 165 in a distributed network such as depicted in FIG. 1. The TRS controller 155 may be further programmed to communicate with various consumer electronics devices 260, such as, without limitation, personal computers (PCs) 262, smart phones 264, tablets 266, and the like, via a suitable data communication link 255 according to one embodiment. Communication link 255 may comprise for example, a wired communication link 270 such as a USB communication link, or a wireless communication link 272 such as a Wi-Fi data link, an IR data link, a Bluetooth data link, a ZigBee data link, etc.

With continued reference to FIG. 2, TRU 200 comprises a refrigerant circuit 212 that generally defines the flow of fluid refrigerant through the TRU 200. A primary fluid path 214 is defined by a compressor 216, a discharge line 218, a condenser 220, a main electronic expansion valve (EXV) 228, and evaporator input line 230, an evaporator 232, and a suction line 234. The compressor 216 is fluidly coupled to the condenser 220 by the discharge line 218. The condenser 220 is fluidly coupled to a main EXV 228. The main EXV 228 is fluidly coupled to the evaporator 232 by the evaporator input line 230.

The primary fluid path 214 is completed via fluidic coupling of the evaporator 232 and the compressor 216.

Refrigerant in its various states flows through the primary fluid path 214 of the refrigerant circuit 212 as described herein. Vaporized refrigerant is delivered to the compressor 216 by the suction line 234. The compressor 216 compresses the vaporized refrigerant by increasing its temperature and pressure. The compressed, vaporized refrigerant is then delivered to the condenser 220 by the discharge line 218.

The condenser 220 receives compressed, vaporized refrigerant from the compressor 216. The condenser 220 is a heat exchanger apparatus used to remove heat from the refrigerant in order to condense the vaporized refrigerant into liquid refrigerant. In the condenser 220, the compressed, vaporized refrigerant releases heat to the air in communication with the condenser 220 in order to cool the vaporized refrigerant. The cooling action of the condenser 220 causes the state of the refrigerant to change from vapor to liquid.

While in the fluid path 214, the cool liquid refrigerant is then delivered to the EXV 228. The EXV 228 is a throttling device that restricts the flow of liquid refrigerant by forcing the liquid refrigerant through a small orifice causing the pressure of the liquid refrigerant to decrease, thereby lowering the boiling point of the refrigerant, making the refrigerant evaporate. As the liquid refrigerant passes through the small orifice of the EXV 228, the liquid refrigerant forms into liquid droplets.

The liquid refrigerant droplets are delivered to the evaporator 232 by evaporator input line 230. The liquid refrigerant droplets delivered to the evaporator 232 absorb heat from warm air flowing into the evaporator 232. The evaporator 232 is located within or in thermal communication with the space being conditioned by the transport refrigeration unit 200. Air is generally circulated between the conditioned space and the evaporator 232 by one or more evaporator fans (not shown). Generally, warmer air flows into the evaporator 232, the liquid refrigerant droplets absorb heat from the warmer air, and cooler air flows out of the evaporator 232. The cooler air flowing out of the evaporator 232 cools the masses in the conditioned space by absorbing heat from the masses within the conditioned space; the warmer air is circulated back to the evaporator 232 by the evaporator fans to be cooled again.

The liquid refrigerant droplets vaporize once they have absorbed sufficient heat, i.e. once the liquid refrigerant droplets reach their saturation or vaporization temperature at a given pressure. The refrigerant, which has changed from liquid refrigerant droplets back to vaporized refrigerant, is then delivered by suction line 234 back to the compressor 216. The delivery of the vaporized refrigerant back to the compressor 216 completes the flow of refrigerant through the fluid path 214.

The TRS controller 155 may be programmed to control various TRU 200 components such as, without limitation, the EXV 228, via communication link 250 in response to data provided by, for example, a plurality of sensors that may comprise an evaporator input temperature sensor 217, an evaporator output temperature sensor 222, a suction pressure sensor 210, a compressor discharge pressure sensor 206, a suction temperature sensor 211, a compressor discharge temperature sensor 208, and at least one sensor 221 coupled to the compressor 216. It will be appreciated that numerous additional sensors or fewer sensors may be employed according to the principles described herein based upon a particular application.

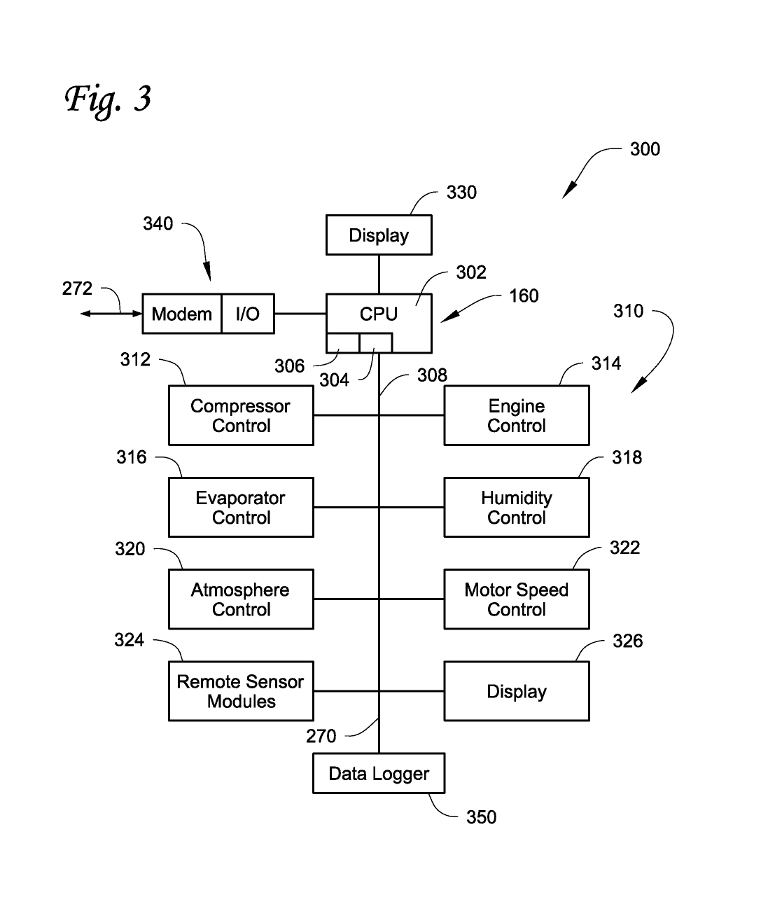

FIG. 3 is a block diagram illustrating a plurality of TRS components 300 typically associated with a transport refrigeration system such as TRS 100 shown in FIG. 1, which may be controlled according to the principles described herein. In this embodiment, TRS components 300 comprise a main programmable controller 160. Programmable controller 160 comprises a data processing unit such as a dedicated DPU or a CPU 302. Programmable controller 160 further comprises an input/output (I/O) controller 304 and predetermined memory elements 306 that may comprise volatile and non-volatile RAM, ROM, EPROM, and variants thereof. I/O controller 304 is connected to a communications bus 308 that allows data communications to take place between the programmable controller 160 and other TRS components 310, 330 340, 350 such as depicted for one embodiment in FIG. 3.

Programmable controller 160 may be connected to a local display device 330 according to one embodiment. Programmable controller 160 may further be connected to remote monitor devices, described herein, via a wired communication link 270 such as, for example, a USB communication link to a data logger 350, or a wireless communication link 272 such as a Wi-Fi data link, an IR data link, or a Bluetooth data link to a PC 262, smart phone 264, or a tablet 266, such as shown in FIG. 2, among others.

Exemplary remote communication nodes which may be connected to data bus 308 comprise, without limitation, a refrigerant compressor controller 312, a compressor prime mover engine controller 314, a refrigerant evaporator controller 316, a conditioned load humidity controller 318, a conditioned load atmosphere controller 320, a motor speed controller 322, such as a compressor prime mover motor, fan and blower motors, and the like, remote sensor modules 324, a display 326, and the data logger or data pack 350.

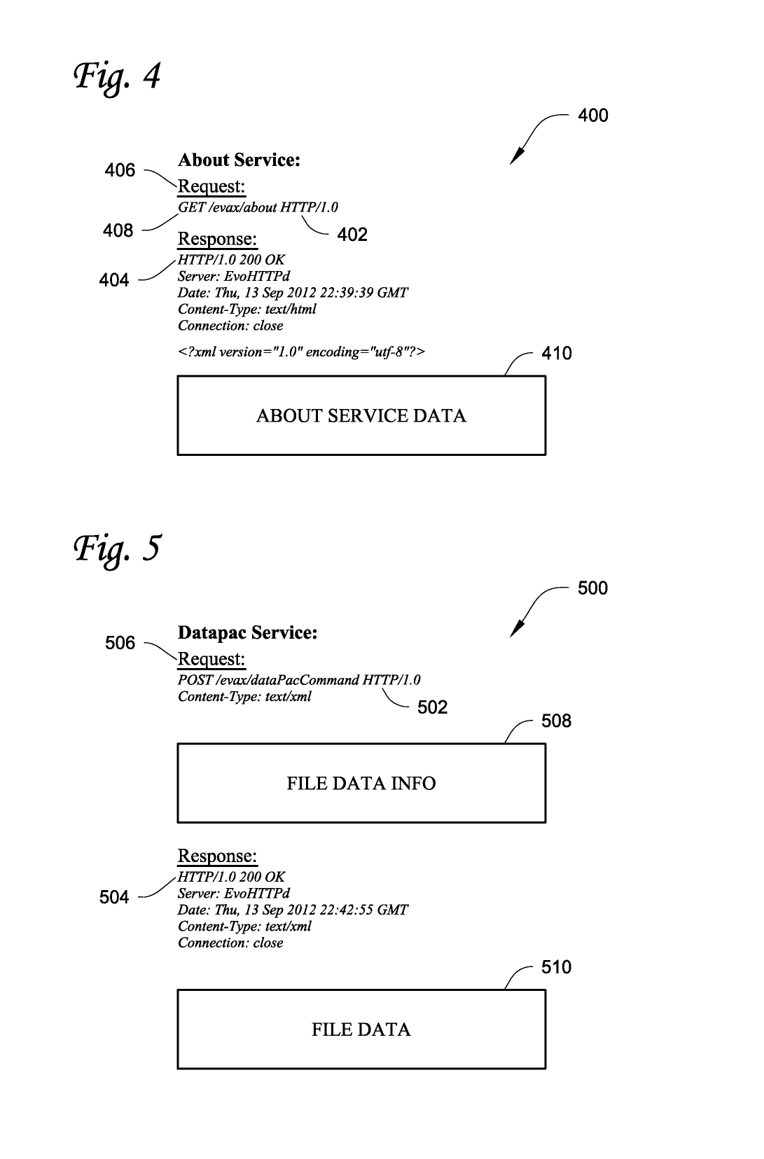

Exemplary embodiments of a communication protocol that may be used to transfer data and/or files between various components in a TRU or between various components in a TRS and various consumer electronics such as discussed herein with reference to FIGS. 1-3, are now described herein with reference to FIGS. 4-7. The exemplary communication protocol embodiments described herein can be easily applied using modern, high speed communication buses and can be readily implemented on many hardware layers using standard communication drivers which are available “off the shelf” to achieve higher data communication rates to improve system performance. Generally, the embodiments described herein provide broad flexibility by using a common communication protocol (e.g., HTTP) as a wrapper around various existing and yet to be determined data transfer protocols. According to one embodiment, standard common communication protocol GET and POST methods are used to perform various operations. According to some embodiments, an operation to be invoked is selected by performing a GET or a POST to various services that are supported by the TRU system components 300. According to one aspect, relevant data may be contained within the body of the common communication protocol message in an instruction set document. This instruction set document can contain whatever data is desired to be transferred, such as datapac commands and/or files.

As shown in FIGS. 4-7, the common communication protocol is HTTP, the instruction set document is a XML document that uses XML as the format language. However, it is appreciated that in other embodiments, the common communication protocol can be any “off the shelf” or publically available communication protocol. Also, it is appreciated that in other embodiments, the instruction set document can use any format language known by the various components in the TRS and the various consumer electronics. In some embodiments, the format language can be a publically known format language such as XML. In other embodiments, the format language can be a proprietary language known and used by the various components in the TRS and the various consumer electronics.

A controller receiving the instruction set document(s) via the HTTP communication protocol then parses or decodes the data contained within the instruction set document into data that is recognized by the controller. The controller can then perform requested services in response to the parsed or decoded data and respond accordingly with the source transmitting the instruction set document.

Current transport refrigeration communication protocols and methods that employ serial data communication techniques can then be applied to implement desired services using modern, high speed communication busses when transmitting relevant data and/or files embedded within an instruction set document that is transported to one or more controllers using the HTTP communication protocol. It will be appreciated that the communication principles described herein allow the implementation of TRS and TRU services via a communication protocol that can be expanded to a theoretically infinite number of uses, simply and efficiently by defining each new service.

Looking now at FIG. 4, a communication protocol 400 according to one embodiment is illustrated. The embodied communication protocol comprises an HTTP protocol 402, 404 as a wrapper around a predetermined data transfer protocol that is in the form of an XML document to implement an “About Service” request 406. The “About Service” allows one TRS and/or TRU component to very quickly get information about another TRS and/or TRU component. Typically, the information obtained is that which is most needed whenever interacting with the TRS and/or TRU component, such as, without limitation, a software revision level, a serial number, and so forth.

According to one aspect, the “About Service” request 406 is invoked by performing a GET request 408 to the desired TRS and/or TRU components about service. The TRS and/or TRU component receiving the request will then return an XML document 410 containing information about itself. The embodied communication protocol advantageously provides a higher level of efficiency with respect to current communication protocols that generally require a separate transaction for each piece of identified data through serial transmission of data and/or files, as stated herein.

FIG. 5 illustrates a communication protocol 500 according to another embodiment. The embodied communication protocol comprises an HTTP protocol 502, 504 as a wrapper around a predetermined data transfer protocol that is in the form of an XML document to implement a “Datapac Service” request 506.

According to one aspect, the “Datapac Service” request 506 allows predetermined TRS and/or TRU datapac commands to be sent in one message, thereby increasing system efficiency compared to the “one at a time” methods generally available in legacy TRSs and/or TRUs. The datapac commands are simply listed in an XML document 508 within the body of the HTTP message. The response to this request contains a list of the datapac responses in an XML document 510 within the body of the HTTP response.

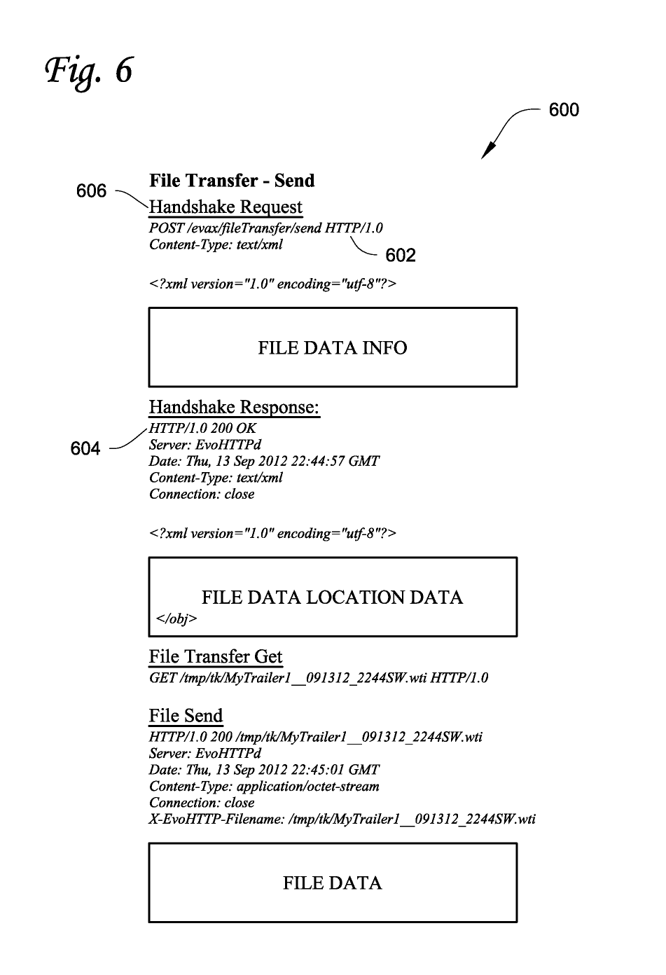

FIG. 6 illustrates a communication protocol 600 according to yet another embodiment. The embodied communication protocol comprises an HTTP protocol 602, 604 as a wrapper around a predetermined data transfer protocol that is in the form of an XML document to implement a “File Transfer—Send” service request 606 according to yet another embodiment. The “File Transfer—Send” service request 606 allows one TRS and/or TRU system component to request a file from another TRS and/or TRU system component. A handshake takes place between the relevant system components before the file is sent. The request portion of the handshake contains details about which file is being requested such as the location from which the file is requested. This location indicates to the sender what type of file is being requested. The response portion of the handshake contains details on how to get the file such as URL and file size. Once the handshake is successfully completed, the requestor performs a GET operation to the URL indicated. This process then results in the requested file being sent.

According to one aspect, a “File Transfer—Send” service request 606 is used for operations such as data logger downloads, predetermined data retrieval, and predetermined master file updates. The communication protocol principles described herein are not so limited however, and it will be appreciated that the principles described herein may be expanded to any operation wherein one system component is required to get a file and/or data from another system component. Such feature rich capabilities are generally not present in legacy TRSs and TRU systems.

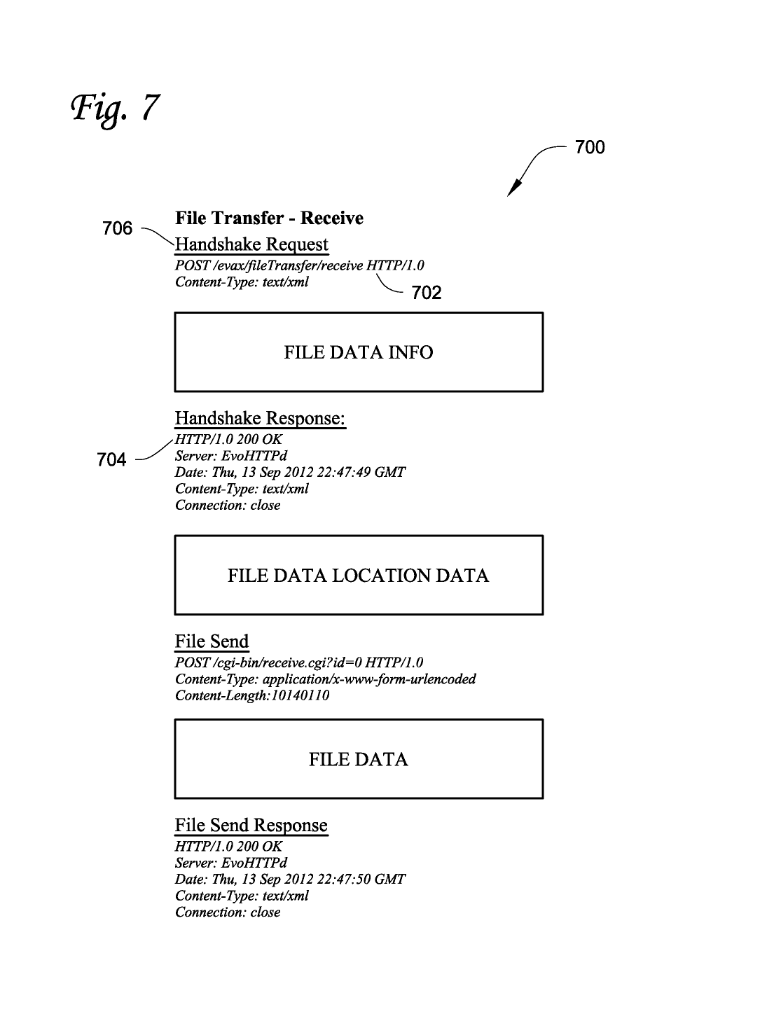

FIG. 7 illustrates a communication protocol 700 according to still another embodiment. The embodied communication protocol comprises an HTTP protocol 702, 704 as a wrapper around a predetermined data transfer protocol that is in the form of an XML document to implement a “File Transfer—Receive Service” request 706 according to still another embodiment. As described herein, a handshake takes place between relevant system components before the file and/or data is sent.

According to one aspect, the request portion of the handshake contains details about which file and/or data is being requested such as file size and the location to which the file and/or data will be sent. This location indicates to the receiver what should be done with the file and/or data.

According to another aspect, the response portion of the handshake contains details on how to send the file and/or data such as destination URL. Once the handshake is successfully completed, the sender performs a POST operation to the designated URL containing the file to be sent. According to one aspect, this process is used for operations such as, without limitation, software upgrades, that may be performed through use of, for example, flashloading. This process may further be used for programming desired operational features or even further expanded to any operation where one TRS and/or TRU system component is required to send a file and/or data to another component. As stated herein, such feature rich capabilities are generally not present in legacy TRSs and TRU systems.

In summary explanation, embodiments described herein are directed to a data communication protocol used to transfer data and/or files between various components in a TRS and/or used to transfer data and/or files between a TRU system and various consumer electronics that my include without limitation, PCs, smart phones and tablet devices. The embodied data communication protocol further allows placement of files and/or commands including, without limitation, predetermined proprietary files and commands within a commonly used common communication protocol wrapper to be easily implemented on many common, modern physical layers using standard communication drivers which are available “off the shelf”. According to one aspect, the relevant proprietary data is contained within the body of the common communication protocol (e.g., HTTP) message in an instruction set document (e.g., an XML document). The principles described herein allow the implementation of services via a communication protocol that can be expanded to a theoretically infinite number of uses simply by defining a new service.

The principles and embodiments described herein provide numerous advantages over legacy TRS and TRU systems. Some of these advantages include, improved software upgrade time, improved data logger download time, improved operational parameter data send and retrieve time, improved refresh rates for monitoring TRS and/or TRU system data points, ability to easily migrate from USB to other hardware layers such as Wi-Fi, Bluetooth, infrared, ZigBee among others, and use of high speed data transfer rates allowing sharing of entire files between TRS and TRU system components.

The embodiments described herein provide a communication scheme that enables proprietary TRS service data contained within an instruction set document to be transferred via a hypertext transfer protocol resulting in a generic data structure common to a substantially non-exhaustive number of predetermined services that are supported by components associated with the TRS. Although particular embodiments may employ other hardware layers such as stated herein, the embodiments described herein advantageously prevent third parties from transferring data/files between various components of a TRS or TRU and consumer electronics. Such consumer electronics may include, without limitation, PCs, smart phones, tablet devices, and so forth, as stated herein.

### Aspects:

It is noted that any of aspects 1-9, 10-16 and 17-29 can be combined.
1. A method of transferring transport refrigeration system (TRS) data associated with a TRS, the method comprising:

programming at least one TRS controller associated with the TRS to transfer predetermined TRS service data contained within an instruction set document via a common communication protocol; and

transferring the instruction set document via the common communication protocol to or from at least one TRS controller associated with the TRS to invoke one or more predetermined services that are supported by components associated with the TRS.
2. The method of transferring TRS data associated with a TRS according to aspect 1, wherein the predetermined TRS service data comprises data associated with predetermined components associated with the TRS.
3. The method of transferring TRS data associated with a TRS according to aspect 1 or 2, further comprising invoking a common communication protocol GET operation in response to the transferred instruction set document to send or receive information about one or more components associated with the TRS.
4. The method of transferring TRS data associated with a TRS according to any of aspects 1-3, further comprising invoking a common communication protocol POST operation in response to the transferred instruction set document to send or receive information between a plurality of components associated with the TRS.
5. The method of transferring TRS data associated with a TRS according to any of aspects 1-4, further comprising invoking an a common communication protocol file transfer send service operation in response to the transferred instruction set document such that data is transported to one or more components associated with the TRS from one or more different components associated with the TRS.
6. The method of transferring TRS data associated with a TRS according to any of aspects 1-5, further comprising invoking an common communication protocol file transfer receive service operation in response to the transferred instruction set document such that data is transported from one or more components associated with the TRS to one or more different components associated with the TRS.
7. The method of transferring TRS data associated with a TRS according to any of aspects 1-6, wherein the predetermined TRS service data contained within an instruction set document and transferred via a common communication protocol defines a generic data structure common to a substantially non-exhaustive number of predetermined services that are supported by components associated with the TRS.
8. The method of transferring TRS data associated with a TRS according to any of aspects 1-7, wherein the instruction set document is an extensible markup language (XML) document using a XML format language.
9. The method of transferring TRS data associated with a TRS according to any of aspects 1-8, wherein the common communication protocol is hypertext transfer protocol (HTTP).
10. A method of transferring transport refrigeration system (TRS) data associated with a TRS, the method comprising:

defining a generic data structure common to a substantially non-exhaustive number of predetermined services that are supported by components associated with the TRS; and

programming at least one TRS controller associated with the TRS to transfer predetermined TRS service data contained within an instruction set document via a common communication protocol, wherein the predetermined TRS service data contained within the instruction set document and transferred via a common communication protocol defines the generic data structure.
11. The method of transferring TRS data associated with a TRS according to aspect 10, further comprising invoking a common communication protocol GET operation in response to the transferred instruction set document to send or receive information about one or more components associated with the TRS, wherein the invoked common communication protocol GET operation data structure conforms to at least a portion of the defined generic data structure.
12. The method of transferring TRS data associated with a TRS according to aspect 10 or 11, further comprising invoking a common communication protocol POST operation in response to the transferred instruction set document to send or receive information between a plurality of components associated with the TRS, wherein the invoked common communication protocol POST operation data structure conforms to at least a portion of the defined generic data structure.
13. The method of transferring TRS data associated with a TRS according to any of aspects 10-12, further comprising invoking a common communication protocol file transfer send service operation in response to the transferred instruction set document such that data is transported to one or more components associated with the TRS from one or more different components associated with the TRS, wherein the invoked common communication protocol file transfer send service data structure conforms to at least a portion of the defined generic data structure.
14. The method of transferring TRS data associated with a TRS according to any of aspects 10-13, further comprising invoking a common communication protocol file transfer receive service operation in response to the transferred instruction set document such that data is transported from one or more components associated with the TRS to one or more different components associated with the TRS, wherein the invoked common communication protocol file transfer receive service data structure conforms to at least a portion of the defined generic data structure.
15. The method of transferring TRS data associated with a TRS according to any of aspects 10-15, wherein the instruction set document is an extensible markup language (XML) document using a XML format language.
16. The method of transferring TRS data associated with a TRS according to any of aspects 10-15, wherein the common communication protocol is hypertext transfer protocol (HTTP).
17. A transport refrigeration system (TRS) comprising:

at least one TRS controller programmed to transfer predetermined TRS service data contained within an instruction set document using a common communication protocol; and

a medium for transferring the XML documents to and from at least one TRS controller using the common communication protocol, wherein the predetermined TRS service data contained within an instruction set document and transferred via the common communication protocol defines a generic data structure common to a substantially non-exhaustive number of predetermined services that are supported by components associated with the TRS.
18. The TRS according to aspect 17, wherein at least one TRS controller comprises a personal computer.
19. The TRS according to aspect 17 or 18, wherein at least one TRS controller comprises a smart phone device.
20. The TRS according to any of aspects 17-19, wherein at least one TRS controller comprises a tablet computing device.
21. The TRS according to any of aspects 17-20, wherein the medium for transferring the instruction set documents to and from at least one TRS controller using the common communication protocol comprises a hardwired communication bus.
22. The TRS according to aspect 21, wherein the hardwired communication bus is a Universal Serial Bus (USB).
23. The TRS according to any of aspects 17-22, wherein the medium for transferring the instruction set documents to and from at least one TRS controller using the common communication protocol comprises a wireless communication path.
24. The TRS according to aspect 23, wherein the wireless communication path comprises a Wi-Fi communication path.
25. The TRS according to aspect 23 or 24, wherein the wireless communication path comprises a Bluetooth communication path.
26. The TRS according to any of aspects 23-25, wherein the wireless communication path comprises an infrared (IR) communication path.
27. The TRS according to any of aspects 23-26, wherein the wireless communication path comprises a ZigBee communication path.
28. The TRS according to any of aspects 17-27, wherein the instruction set document is an extensible markup language (XML) document using a XML format language.
29. The TRS according to any of aspects 17-28, wherein the common communication protocol is hypertext transfer protocol (HTTP).

Other distinctive features provided by the embodiments and principles described herein include the ability to send multiple datapac commands in one message, thus improving system efficiency. Further, the embodied “About Service” communication protocol allows vital system component information to be shared in a single transaction.

While only certain features of the embodiments have been illustrated and described herein, many modifications and changes will occur to those skilled in the art. It is, therefore, to be understood that the appended claims are intended to cover all such modifications and changes as fall within the true spirit of the embodiments described herein.

1. A method of transferring transport refrigeration system (TRS) data associated with a TRS, the method comprising:
programming at least one TRS controller associated with the TRS to transfer predetermined TRS service data contained within an extensible markup language (XML) document via a hypertext transfer protocol (HTTP); and
transferring the XML document via the HTTP communication protocol to or from at least one TRS controller associated with the TRS to invoke one or more predetermined services that are supported by components associated with the TRS.

2. The method of transferring TRS data associated with a TRS according to claim 1, wherein the predetermined TRS service data comprises data associated with predetermined components associated with the TRS.

3. The method of transferring TRS data associated with a TRS according to claim 1, further comprising invoking an HTTP GET operation in response to the transferred XML document to send or receive information about one or more components associated with the TRS.

4. The method of transferring TRS data associated with a TRS according to claim 1, further comprising invoking an HTTP POST operation in response to the transferred XML document to send or receive information between a plurality of components associated with the TRS.

5. The method of transferring TRS data associated with a TRS according to claim 1, further comprising invoking an HTTP file transfer send service operation in response to the transferred XML document such that data is transported to one or more components associated with the TRS from one or more different components associated with the TRS.

6. The method of transferring TRS data associated with a TRS according to claim 1, further comprising invoking an HTTP file transfer receive service operation in response to the transferred XML document such that data is transported from one or more components associated with the TRS to one or more different components associated with the TRS.

7. The method of transferring TRS data associated with a TRS according to claim 1, wherein the predetermined TRS service data contained within an extensible markup language (XML) document and transferred via a hypertext transfer protocol defines a generic data structure common to a substantially non-exhaustive number of predetermined services that are supported by components associated with the TRS.

8. A method of transferring transport refrigeration system (TRS) data associated with a TRS, the method comprising:
defining a generic data structure common to a substantially non-exhaustive number of predetermined services that are supported by components associated with the TRS; and
programming at least one TRS controller associated with the TRS to transfer predetermined TRS service data contained within an extensible markup language (XML) document via a hypertext transfer protocol (HTTP), wherein the predetermined TRS service data contained within an XML document and transferred via a hypertext transfer protocol defines the generic data structure.

9. The method of transferring TRS data associated with a TRS according to claim 8, further comprising invoking an HTTP GET operation in response to the transferred XML document to send or receive information about one or more components associated with the TRS, wherein the invoked HTTP GET operation data structure conforms to at least a portion of the defined generic data structure.

10. The method of transferring TRS data associated with a TRS according to claim 8, further comprising invoking an HTTP POST operation in response to the transferred XML document to send or receive information between a plurality of components associated with the TRS, wherein the invoked HTTP POST operation data structure conforms to at least a portion of the defined generic data structure.

11. The method of transferring TRS data associated with a TRS according to claim 8, further comprising invoking an HTTP file transfer send service operation in response to the transferred XML document such that data is transported to one or more components associated with the TRS from one or more different components associated with the TRS, wherein the invoked HTTP file transfer send service data structure conforms to at least a portion of the defined generic data structure.

12. The method of transferring TRS data associated with a TRS according to claim 8, further comprising invoking an HTTP file transfer receive service operation in response to the transferred XML document such that data is transported from one or more components associated with the TRS to one or more different components associated with the TRS, wherein the invoked HTTP file transfer receive service data structure conforms to at least a portion of the defined generic data structure.

13. A transport refrigeration system (TRS) comprising:
at least one TRS controller programmed to transfer predetermined TRS service data contained within an extensible markup language (XML) document using a hypertext transfer protocol (HTTP); and
a medium for transferring the XML documents to and from at least one TRS controller using the HTTP protocol, wherein the predetermined TRS service data contained within an XML document and transferred via the HTTP protocol defines a generic data structure common to a substantially non-exhaustive number of predetermined services that are supported by components associated with the TRS.

14. The TRS according to claim 13, wherein at least one TRS controller comprises a personal computer.

15. The TRS according to claim 13, wherein at least one TRS controller comprises a smart phone device.

16. The TRS according to claim 13, wherein at least one TRS controller comprises a tablet computing device.

17. The TRS according to claim 13, wherein the medium for transferring the XML documents to and from at least one TRS controller using the HTTP communication protocol comprises a hardwired communication bus.

18. The TRS according to claim 17, wherein the hardwired communication bus is a Universal Serial Bus (USB).

19. The TRS according to claim 13, wherein the medium for transferring the XML documents to and from at least one TRS controller using the HTTP communication protocol comprises a wireless communication path.

20. The TRS according to claim 19, wherein the wireless communication path comprises a Wi-Fi communication path.

21. The TRS according to claim 19, wherein the wireless communication path comprises a Bluetooth communication path.

22. The TRS according to claim 19, wherein the wireless communication path comprises an infrared (IR) communication path.
